(19) United States
(12) Patent Application Publication
(10) Pub. No.: US 2020/0281131 A1
(43) Pub. Date: Sep. 10, 2020

(54) GROW TUBE

(71) Applicant: Polyform, Inc., Salem, OR (US)

(72) Inventors: Patrick Kohls, Las Vegas, NV (US); Jonathan Kohls, Salem, OR (US)

(73) Assignee: Polyform, Inc., Salem, OR (US)

(21) Appl. No.: 16/808,236

(22) Filed: Mar. 3, 2020

Related U.S. Application Data
(60) Provisional application No. 62/813,572, filed on Mar. 4, 2019.

(51) Int. Cl. A01G 13/02

(52) U.S. Cl. CPC A01G 13/0243; A01G 13/0237

(57) ABSTRACT

A grow tube includes a first side, a second side, a first end portion, a second end portion, a first edge portion, a second edge portion, and a vent. The second side is opposite the first side, the second end portion is opposite the first end portion, the second edge portion is opposite the first edge portion, and the first and second edge portions and the first and second end portions define the first and second sides. The vent extends between the first side and the second side and comprises a flap and an opening. The vent can be V-shaped in some instances. The grow tube can also include one or more locking tabs and/or adjustment mechanisms, which allow the grow tube to be moved between tubular and flat configurations and/or allow a diameter of the grow tube in the tubular configuration to be adjusted, respectively.

### CROSS-REFERENCE TO RELATED APPLICATION

This application claims priority to U.S. Provisional Patent Application No. 62/813,572, filed on Mar. 4, 2019. The provisional application is incorporated by reference herein.

### FIELD

This disclosure relates generally to devices and methods for protecting trees, shrubs, and vines.

### BACKGROUND

Plants such as trees, shrubs, and vines are susceptible to various conditions or forces that can inhibit their growth. In some instances, these conditions or forces can damage or even kill the plant. This is particularly true during early stages of plant growth. Some forces that can harm or kill a plant are animals eating or contacting the plant. For example, deer frequently eat saplings and/or rub their antlers against the plant, which can kill or severely damage the plant. Other forces that can harm or kill a plant include contact with herbicides and pesticides that are sprayed around the plant. As a result, devices and methods for protecting plants are desirable.

### SUMMARY

Disclosed herein are devices and methods for protecting plants. The disclosed devices and methods include grow tubes configured to protect plants (e.g., trees, shrubs, and vines) from various conditions or forces that can kill or inhibit the growth of the plants. The disclosed grow tubes have one or more features not found in typical grow tubes. These features can improve plant growth. The disclosed grow tubes are also relatively simple and inexpensive to manufacture compared to typical grow tubes. The disclosed grow tubes can also be transported more efficiently and easily than typical grow tubes. In some embodiments, the grow tubes include a simple adjustment mechanism, which makes the grow tubes simple and easy to use in a variety of applications and/or plant sizes.

In one representative embodiment, a grow tube includes a first side, a second side, a first end portion, a second end portion, a first edge portion, a second edge portion, a first opening, and a locking tab. The second side is opposite the first side, the second end portion is opposite the first end portion, the second edge portion is opposite the first edge portion, and the first and second edge portions and the first and second end portions define the first and second sides. The first opening extends between the first side and the second side and is disposed adjacent to the first edge portion. The locking tab is disposed on the first and second sides, between the first and second edge portions, and adjacent to the second edge portion. The locking tab includes locking surfaces configured to engage the first side or the second side adjacent to the first opening and to retain the first and second edge portions together. The grow tube forms a tubular configuration when the first and second edge portions are releasably secured together by the locking tab.

In some embodiments, the first opening is defined by a receiving tab.

In some embodiments, the locking tab has a stem portion and a main body portion, and wherein the locking surfaces are disposed between the stem portion and the main body portion.

In some embodiments, the locking tab has a clamshell shape.

In some embodiments, the grow tube further comprises a second opening extending between the first side and the second side. The second opening is defined by the locking tab and is configured for receiving a receiving tab that defines the first opening.

In some embodiments, the first opening is one of a plurality of first openings, the locking tab is one of a plurality of locking tabs, and each of the locking tabs is configured to interlock with a respective first opening.

In some embodiments, the grow tube is formed from a single-wall material.

In some embodiments, the grow tube is movable between the tubular configuration and a flat configuration.

In some embodiments, the grow tube further comprises an adjustment mechanism configured for adjusting a diameter of the grow tube in the tubular configuration.

In some embodiments, the first opening is one of a plurality of first openings, and wherein the adjustment mechanism comprises the plurality of first openings and the locking tab.

In some embodiments, the first and second sides comprise a vent configured to allow airflow through the grow tube.

In some embodiments, the vent comprises a flap and an opening.

In some embodiments, the vent comprises a V-shape.

In another representative embodiment, a grow tube includes a first side, a second side, a first end portion, a second end portion, a first edge portion, a second edge portion, and a vent. The second side is opposite the first side, the second end portion is opposite the first end portion, the second edge portion is opposite the first edge portion, and the first and second edge portions and the first and second end portions define the first and second sides. The vent extends between the first side and the second side and comprises a flap and an opening.

In some embodiments, the flap of the vent is V-shaped.

In some embodiments, the flap of the vent is triangle shaped.

In some embodiments, the flap of the vent is W-shaped.

In some embodiments, the flap of the vent is rectangular shaped.

In some embodiments, the flap of the vent is semi-circular shaped.

In some embodiments, the flap of the vent is semi-ovular shaped.

In some embodiments, the flap of the vent is configured to prevent a fluid from contacting a plant disposed within the grow tube.

In some embodiments, the flap of the vent is configured to direct a fluid away from the opening of the vent when the fluid is disposed on the first side of the grow tube.

In another representative embodiment, a grow tube includes a first side, a second side, a first end portion, a second end portion, a first edge portion, a second edge portion, and an adjustment mechanism. The second side is opposite the first side, the second end portion is opposite the first end portion, the second edge portion is opposite the first edge portion, and the first and second edge portions and the first and second end portions define the first and second sides. The adjustment mechanism comprises a plurality of openings and one or more tabs. The tabs are configured to selectively engage the grow tube adjacent to respective openings, thereby releasably securing the grow tube in a tubular configuration. The adjustment mechanism allows the grow tube to be positioned in a plurality of diameters in the tubular configuration.

In some embodiments, the openings are spaced apart from each other and aligned in a row extending between the first edge portion and the second edge portion.

In some embodiments, the openings are spaced apart from each other and aligned in a column extending between the first end portion and the second end portion.

In some embodiments, the tabs are locking tabs.

In some embodiments, the adjustment mechanism is integrally formed with the first and second sides.

In some embodiments, the openings comprise slits.

In some embodiments, the openings are defined by receiving tabs.

The foregoing and other objects, features, and/or advantages of the disclosed technology will become more apparent from the following description, which proceeds with reference to the accompanying figures, as well as the claims and accompanying drawings.

### BRIEF DESCRIPTION OF THE DRAWINGS

FIG. 1 depicts an elevation view of a first side of an exemplary grow tube, showing the grow tube in a flat configuration.

FIG. 2 depicts a plan view of a first edge portion of the grow tube of FIG. 1, showing the grow tube in the flat configuration.

FIG. 3 depicts a plan view of a first end portion of the grow tube of FIG. 1, showing the grow tube in the flat configuration.

FIG. 4 depicts a detail view of a first tab of the grow tube of FIG. 1, showing the grow tube in the flat configuration.

FIG. 5 depicts a detail view of an anchor-receiving opening of the grow tube of FIG. 1, showing the grow tube in the flat configuration.

FIG. 6 depicts a detail view of a second tab of the grow tube of FIG. 1, showing the grow tube in the flat configuration.

FIG. 7 depicts an elevation view of the first side of the grow tube of FIG. 1, showing the grow tube in a tubular configuration.

FIG. 8 depicts a partial perspective view of the grow tube of FIG. 1, showing the grow tube in the tubular configuration.

FIG. 9 depicts a perspective view of the grow tube of FIG. 1, together with an exemplary anchoring member and disposed around a tree, and showing the grow tube in the tubular configuration.

FIG. 10 depicts an elevation view of a first side of an exemplary grow tube having a vent, showing the grow tube in a flat configuration.

FIG. 11 depicts a perspective view of the grow tube of FIG. 10, showing the grow tube in a tubular configuration.

FIG. 12 depicts a detail view of the vent of the grow tube, showing the grow tube in the tubular configuration.

FIG. 13 depicts an elevation view of a first side of an exemplary grow tube having an adjustment mechanism, showing the grow tube in a flat configuration.

FIG. 14 depicts an elevation view of a first side of an exemplary grow tube having an adjustment mechanism and a vent, showing the grow tube in a flat configuration.

FIGS. 15-17 depict perspective views of the grow tube of FIG. 13, showing the grow tube in the tubular configuration and adjusted to various diameters.

FIG. 18 depicts an elevation view of a first side of an exemplary grow tube, showing the grow tube in a flat configuration.

FIG. 19 depicts an elevation view of a first side of an exemplary grow tube, showing the grow tube in a flat configuration.

FIG. 20 depicts an elevation view of a first side of an exemplary grow tube, showing the grow tube in a flat configuration.

FIG. 21 depicts a side elevation view of the grow tube of FIG. 20, showing the grow tube in a first tubular configuration.

FIG. 22 depicts a side elevation view of the grow tube of FIG. 20, showing the grow tube in a second tubular configuration.

### DETAILED DESCRIPTION

General Considerations

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language. For example, operations described sequentially (e.g., assembly or disassembly of a grow tube) may in some cases be rearranged or performed concurrently. Moreover, for the sake of simplicity, the attached figures may not show the various ways in which the disclosed methods can be used in conjunction with other methods. As used herein, the terms “a”, “an” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C,” or “A, B, and C.”

As used herein, the term “coupled” generally means physically coupled or linked. Two components that are coupled to the each other can be directly connected to each other or can be indirectly connected to each other with one or more intermediate elements between the coupled items.

As used herein the term “grow tube” means a device configured for facilitating growth of a plant and/or protecting the plant. For example, grow tubes include devices that can help a tree sapling or a vine cutting to grow. Grow tubes also include, for example, devices that are configured to protect a plant from animals (e.g., insects, rodents, etc.) and/or chemicals (e.g., pesticides, herbicides, etc.).

### Exemplary Embodiments

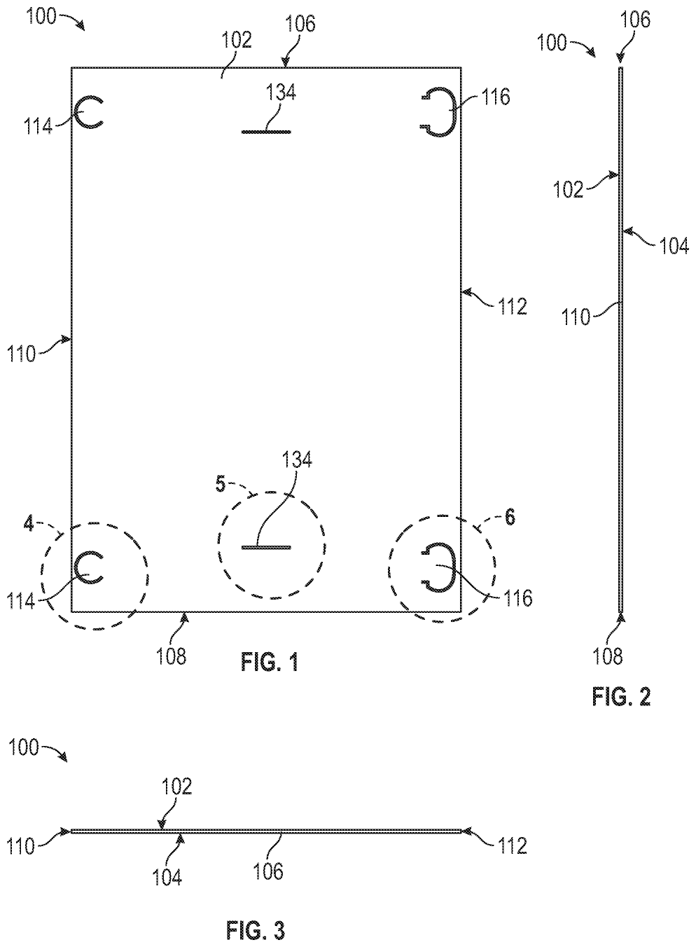

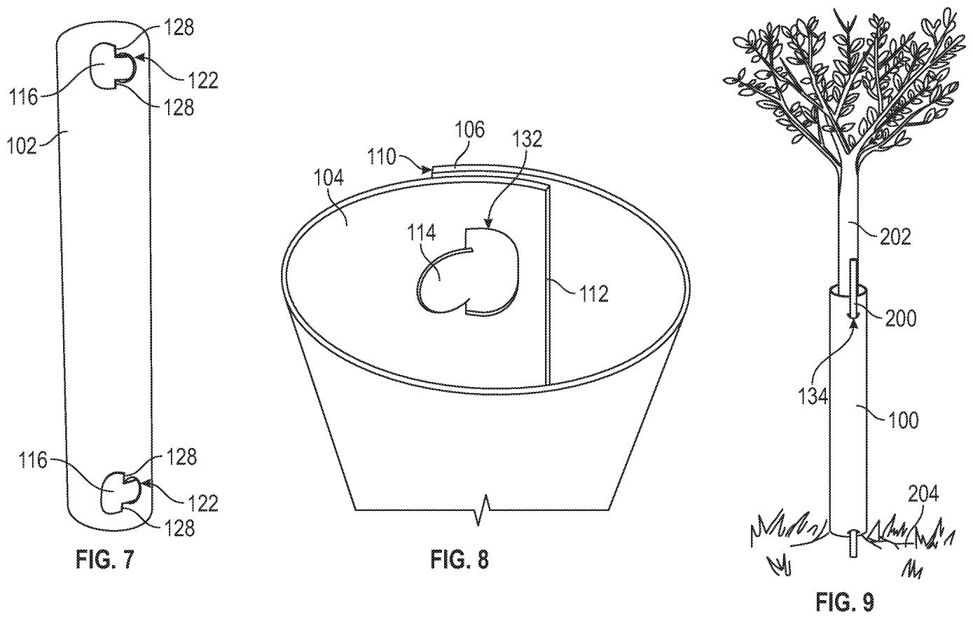

FIGS. 1-9 show a grow tube 100, according to one embodiment. The grow tube 100 can be placed around a plant to protect the plant, as shown in FIG. 9. The grow tube 100 can be formed of a thin, flexible material. This allows the grow tube 100 to be moved between a flat configuration and a tubular configuration. FIG. 1 shows the grow tube 100 in the flat configuration. The flat configuration can be used, for example, when storing and/or transporting the grow tube 100. FIGS. 7-9 show the grow tube 100 in the tubular configuration. The tubular configuration can be used, for example, when positioning the grow tube 100 around the trunk or stem of a plant (see, e.g., FIG. 9) to protect the plant. In some embodiments, the grow tube 100 can comprise integrated locking features which allow the grow tube 100 to be quickly and easily moved between the flat and tubular configurations, as further explained below.

Referring to FIGS. 1-3, the grow tube 100 can comprise a first side 102, a second side 104, a first end portion 106, a second end portion 108, a first edge portion 110, and a second edge portion 112. The grow tube 100 can be folded into the tubular configuration by radially overlapping the first and second edge portions 110, 112, as shown in FIGS. 7-8.

To releasably secure the first and second edge portions 110, 112 in the overlapping configuration, the grow tube can, in some embodiments, include one or more integrally formed locking features. The locking features can comprise a locking element and a receiving element. In some embodiments, the locking element can, for example, be a tab or a flap, and the receiving element can, for example, an opening (which, in some instances, can be defined by a flap or tab) or a slit. For example, in the illustrated embodiment, the grow tube 100 comprises first tabs 114 (which can also be referred to as “receiving elements”) located adjacent to the first edge portion 110 of the grow tube 100 and second tabs 116 (which can also be referred to as “locking elements”) located adjacent to the second edge portion 112 of the grow tube 100. In the illustrated embodiment, the grow tube 100 has two first tabs 114 and two second tabs 116 (i.e., a first pair of first and second tabs 114, 116 disposed adjacent to the first end portion 106 of the grow tube 100 and a second pair of first and second tabs 114, 116 disposed adjacent to the second end portion 108 of the grow tube 100).

In other embodiments, the grow tube 100 can have more or less than two pairs of tabs and/or the tabs can be located at various other locations. For example, in lieu of or in addition to the first and second pairs of tabs 114, 116, the grow tube 100 can comprise a pair of tabs located at an intermediate location between the first and second end portions 106, 108 (e.g., proximate to the middle of the grow tube).

As shown in FIGS. 7-8, each of the first tabs 114 interlocks with a respective second tab 116 to retain the grow tube 100 in the tubular configuration. The grow tube 100 can also be moved from the tubular configuration to the flat configuration by disengaging the first and second tabs 114, 116 from each other. In this manner, the grow tube 100 can be moved between the flat and tubular configurations quickly, easily, and without requiring additional fasteners (e.g., zip-ties, rivets, screws, etc.). This also allows the grow tubes 100 to be re-useable.

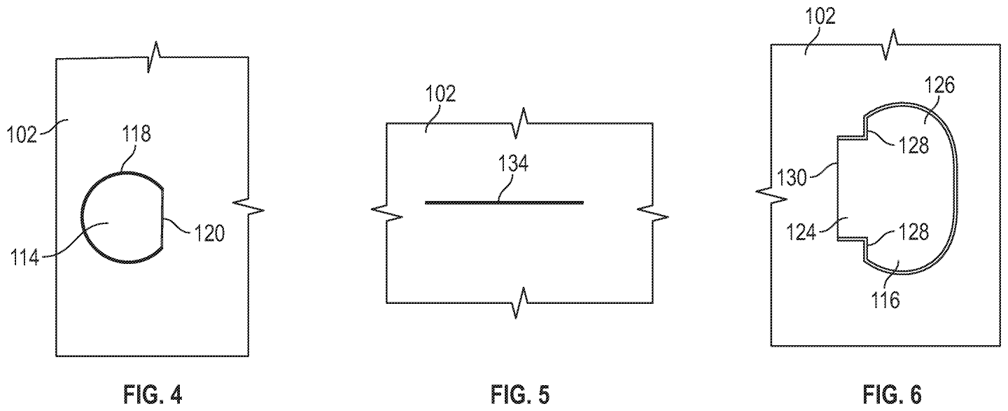

Referring to FIG. 4, in some embodiments, the first tabs 114 can be generally semi-circular shaped. The first tabs 114 can be formed by making a generally “C-shaped” cut 118 that extends through the first and second sides 102, 104 of the grow tube 100. As shown in FIGS. 7-8, the first tabs 114 can be folded inwardly (e.g., along a first fold line 120) such that the first tabs 114 extend away from the second side 104 of the grow tube 100 (or vice versa). Folding the first tabs 114 in this manner creates first openings 122 (which can also be referred to as “receiving openings”), as shown in FIG. 7.

Referring to FIG. 6, in some embodiments, the second tabs 116 can be generally “clamshell” shaped with base or stem portions 124 and main body portions 126 extending from the stem portions 124. The second tabs 116 have locking surfaces 128 disposed between the stem portions 124 and the main body portions 126. As best shown in FIGS. 6-7, the second tabs 116 can be folded outwardly (e.g., along a second fold line 130) such that the second tabs 116 extend outwardly from the first side 102 of the grow tube 100 (or vice versa). Folding the second tabs 116 in this manner creates second openings 132 (defined by the second tabs 116), as shown in FIG. 8.

As shown in FIGS. 7-8, the grow tube 100 can be assembled in the tubular configuration by radially overlapping the first and second edge portions 110, 112 of the grow tube and interlocking the first tabs 114 with respective second tabs 116. The first and second tabs 114, 116 can be interlocked by inserting the first tabs 114 through respective second opening 132 such that the first tabs 114 extend from the first side 102 of the grow tube to the second side 104 of the grow tube 100 (or vice versa), as shown in FIG. 8. The first and second tabs 114, 116 are further interlocked by folding the main body portions 126 of the second tabs and inserting the second tabs 116 through respective first openings 122 such that the second tabs 116 extend from the second side 104 of the grow tube 100 to the first side 102 of the grow tube 100 (or vice versa), as shown in FIG. 7.

Referring still to FIG. 7, in some embodiments, the main body portions 126 of the second tabs 116 can be configured so as to be larger than the first openings 122. As a result, the locking surfaces 128 of the second tabs 116 engage the first side 102 of the grow tube 100 adjacent to respective first openings 122. Thus, the locking surfaces 128 can prevent the second tabs 116 from inadvertently retracting through the first openings 122 when a radial force is applied to the grow tube 100.

In other embodiments, the first and second tabs 114, 116 can comprise various shapes and/or locking features. For example, in some embodiments, the second tabs 116 can be generally “arrow” shaped. In such embodiments, the “head” of the arrow comprises locking surfaces configured to engage the grow tube adjacent to an opening and/or slit (e.g., similar to the locking surfaces 128 of the second tab 116) and the “shaft” of the arrow can be configured to extend through an opening or slit (e.g., similar to the stem portion 124 of the second tab 116).

Forming the first and/or second tabs 114, 116 as tabs disposed between the first and second edge portions 110, 112 (rather than as projections extending outwardly from an edge) can provide one or more advantages. For example, it can improve interlocking because each tab also forms an opening from receiving another tab. It can also reduce raw material consumption. It can also reduce the likelihood that the tabs will be damaged during shipping and/or storage.

Referring again to FIG. 1, the grow tube 100 can also comprise one or more anchoring features that are configured to secure the grow tube 100 relative to the ground. For example, the grow tube 100 can include a plurality of anchor-receiving openings 134 (e.g., two in the illustrated embodiment). As shown in FIG. 5, the anchor-receiving openings 134 can be formed by making a generally horizontal slit that extends through the first and second sides 102, 104 of the grow tube 100. The anchor-receiving openings 134 can be configured for receiving an anchoring member (e.g., a stake 200), as shown in FIG. 9. The stake 200 can be used, for example, to secure the grow tube 100 relative to a tree 202 and the ground 204.

In other embodiments, the grow tube 100 can comprise more or less than two (e.g., 1 or 3-6) anchor-receiving openings 134 and/or the location of the anchor-receiving openings 134 on the grow tube 100 can be altered.

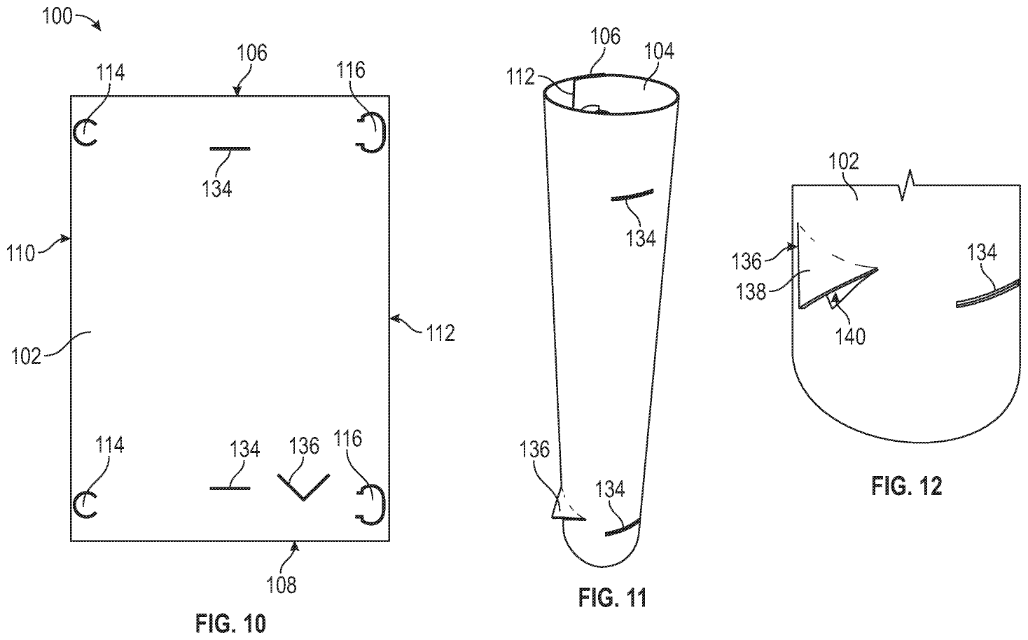

In some embodiments, the grow tube 100 can comprise a vent. The vent can be configured to allow airflow through the grow tube 100 while also reducing the likelihood that materials (e.g., chemicals such as pesticide and herbicide) will enter the grow tube 100 through the vent and contact a plant disposed within the grow tube. For example, FIGS. 10-12 show the grow tube 100 with an optional vent 136. As shown in FIG. 12, the vent 136 comprises a flap 138 and an opening 140. The opening 140 of the vent 136 is configured to allow airflow into and/or through the grow tube 100, and the flap 138 of the vent 136 is configured to reduce the likelihood that materials (e.g., chemicals such as pesticide and herbicide) will enter the grow tube 100 through the opening 140 and contact a plant disposed within the grow tube.

The vent 136 allows air to flow into the grow tube 100 through the opening 140 of the vent 136. In some instances, the vent 136 can create an updraft of airflow through the interior (i.e., the second side 104) of the grow tube 100 as air flows through the opening 140 and upwardly toward the first end portion 106 of the grow tube 100. Also, when chemicals are sprayed onto the first side 102 of the grow tube 100, the flap 138 of the vent 136 partially covers the opening 140 of the vent 136 and can prevent the chemicals from entering the grow tube 100 through the opening 140 (particularly when chemicals are sprayed from a height above the vent 136 and below the first end portion 106 of the grow tube 100). As a result, the chemicals will run down the grow tube 100 and, rather than running into the grow tube 100 through the opening 140, the chemicals will drip off the tip of the flap 138 onto the ground at a location outside of the grow tube 100.

Configuring the vent 136 with the flap 138 (rather than just an uncovered opening) can provide one or more advantages. For example, the flap 138 allows air flow through the opening 140 but also prevents or reduces the likelihood that chemical spray on or around the grow tube 100 will inadvertently enter the interior of the grow tube 100 through the opening 140 and contact a plant disposed within the grow tube.

Although the flap 138 of the vent 136 is shown extending radially outwardly in FIGS. 11 and 12, the flap 138 can, in some instances, extend radially inwardly. A radially inwardly extending flap can be configured to direct material onto the ground at a location spaced apart from the plant.

In the illustrated embodiment, the vent 136 is configured in a “V” or triangle shape. Configuring the flap 138 in this shape can provide one or more advantages. For example, the V-shaped flap 138 acts like a funnel that can direct chemical spray away from the opening 140. In other embodiments, the vent 136 can have another shape (e.g., rectangular, semi-circular, semi-ovular, W-shaped, etc.), each of which has particular advantages.

Although the illustrated embodiment depicts only one vent, in other embodiments, the grow tube can include more than one vent. For example, in some embodiments, the grow tube 100 can have 2-10 vents.

In the illustrated embodiment, the vent 136 is disposed generally adjacent to the second end portion 108 of the grow tube 100. This location can provide particular advantages such as providing an updraft airflow direction through the grow tube. It can also reduce the chance that chemical spray will enter the grow tube 100 through the vent 136 because sources of chemical spray are typically located above the location of the vent 136.

In other embodiments, the vent 136 can be disposed at various locations on the grow tube 100. For example, the vent can be disposed closer to the first end portion 106 of the grow tube 100 and/or moved closer toward either the first or second edge portion of the grow tube than depicted in the illustrated embodiment.

In some embodiments, a grow tube can comprise a vent (e.g., the vent 136) but can omit other features of the grow tube 100 (e.g., the first and/or second tabs 114, 116). In such, embodiments, the grow tube may include one or more openings or slits and/or one or more coupling members configured to secure the grow tube in a tubular configuration. For example, the coupling member can be a fastener (e.g., a tip-tie, rivet, screw, etc.), a stake or rod, or other means for coupling. The grow tube can be coupled together by overlapping the edges of the grow tube and inserting a stake through the openings or slits of the grow tube to retain the grow tube in the tubular configuration.

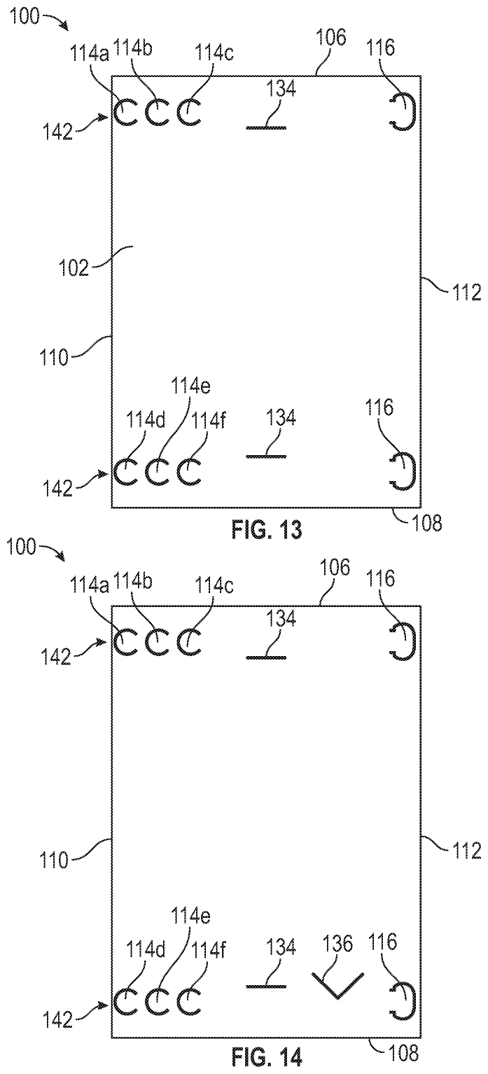

In some embodiments, the grow tube 100 can include an adjustment mechanism that allows the diameter of the grow tube 100 in the tubular configuration to be adjusted to a desired size. For example, FIG. 13 shows the grow tube 100 with an optional adjustment mechanism 142. In the illustrated embodiment, the adjustment mechanism 142 comprises a plurality of first tabs 114 adjacent to each end portion 106, 108 of the grow tube 100. Specifically, the grow tube 100 includes three first tabs 114a, 114b, 114c adjacent to the first end portion 106 of the grow tube 100 and three first tabs 114d, 114e, 114f adjacent to the second end portion 108 of the grow tube 100. In other embodiments, the grow tube can have more or less than three (e.g., 2-5) first tabs 114 adjacent to each end portion of the grow tube.

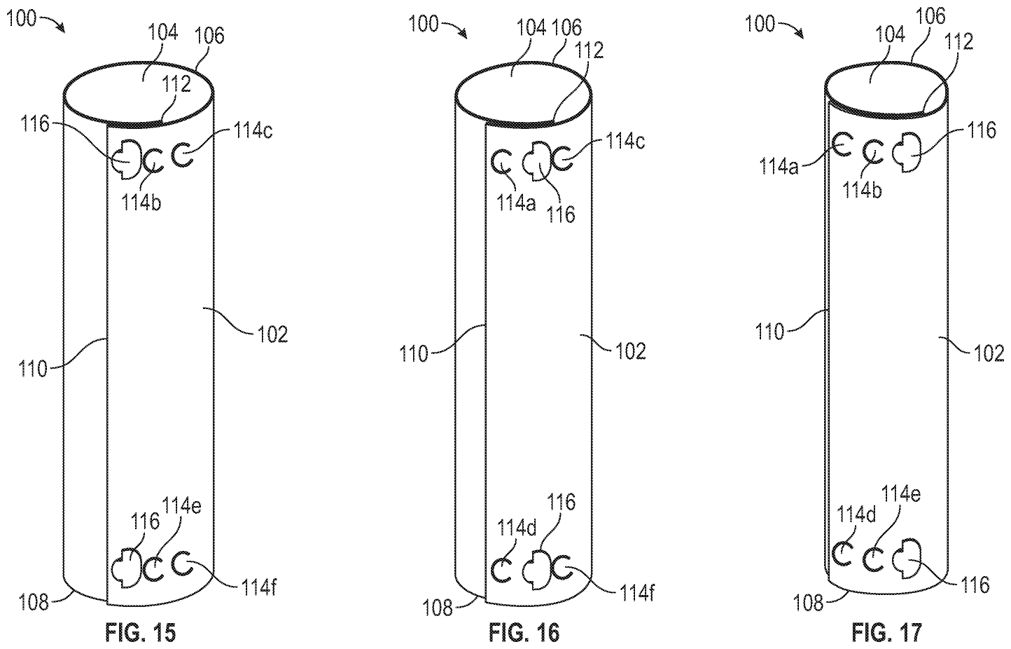

As shown in FIGS. 15-17, the adjustment mechanism 142 (FIG. 13) allows the grow tube 100 to be adjusted to various diameters. For example, FIG. 15 shows the grow tube 100 in a first tubular configuration in which the first tabs 114a, 114d are interlocked with respective second tabs 116. FIG. 16 shows the grow tube 100 in a second tubular configuration in which the first tabs 114b, 114e are interlocked with respective second tabs 116. FIG. 17 shows the grow tube 100 in a third tubular configuration in which the first tabs 114c, 114f are interlocked with respective second tabs 116. The grow tube 100 has a larger diameter in the first tubular configuration (FIG. 15) than in the second configuration (FIG. 16) and the third configuration (FIG. 17), and the grow tube 100 has a larger diameter in the second configuration than in the third configuration.

In other embodiments, the adjustment mechanism can comprise only two first tabs 114 (i.e., one first tab adjacent to the first end portion 106 of the grow tube 100 and another first tab 114 adjacent to the second end portion 108 of the grow tube 100, see, e.g., FIG. 1), a first plurality of second tabs 116 (e.g., 2-5 second tabs) disposed adjacent to the first end portion 106 of the grow tube 100 and a plurality of second tabs 116 (e.g., 2-5 second tabs) disposed adjacent to the second end portion 108 of the grow tube 100.

In yet other embodiments, the adjustment mechanism can comprise a first plurality of first tabs 114 and a first plurality of second tabs 116 disposed adjacent to the first end portion 106 of the grow tube 100 and a second plurality of first tabs 114 and a second plurality of second tabs 116 disposed adjacent to the second end portion 108 of the grow tube 100. Such embodiments can, for example, provide a more secure connection between the first and second edge portions 110, 112.

In some embodiments, the grow tube 100 can comprise a vent and an adjustment mechanism. For example, FIG. 14 shows the grow tube 100 with the vent 136 and the adjustment mechanism 142.

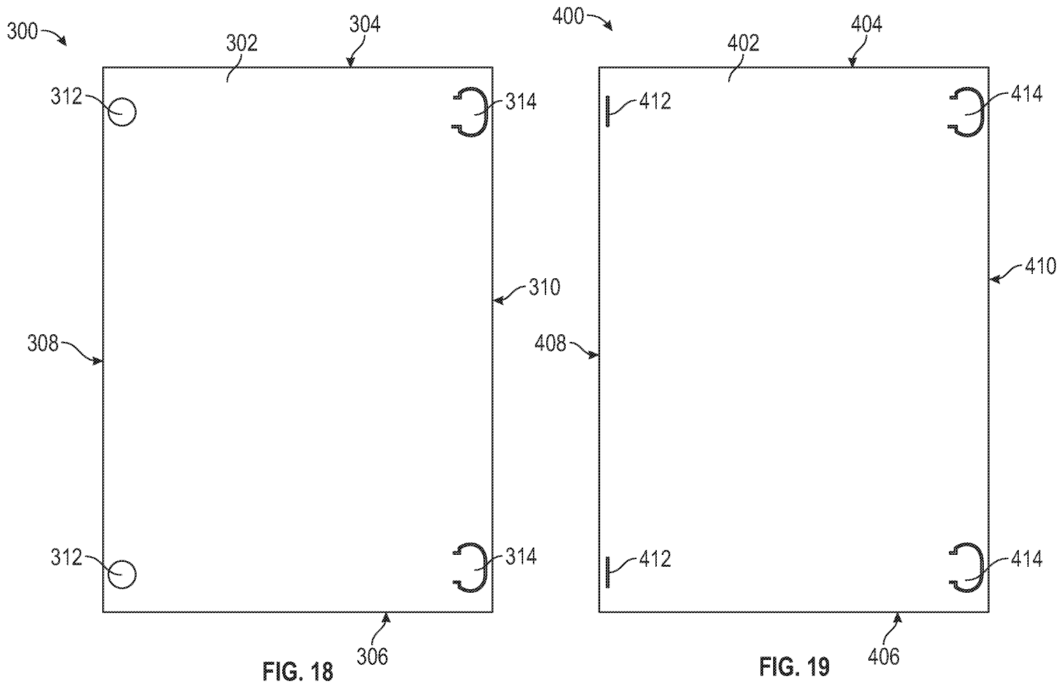

FIG. 18 shows a grow tube 300, according to another embodiment. The grow tube 300 can comprise a first side 302, a second side (not shown), a first end portion 304, a second end portion 306, a first edge portion 308, and a second edge portion 310. Although not shown, the grow tube 300 can be folded into the tubular configuration by radially overlapping the first and second edge portions 308, 310 (e.g., similar to the manner shown in FIGS. 7-8 with the grow tube 100).

The grow tube 300 can further comprise integrally formed locking features to retain the grow tube in the tubular configuration. For example, the locking features of the grow tube 300 comprise receiving elements (e.g., openings 312) and locking elements (e.g., locking tabs 314). The locking tabs 314 can be inserted through the openings 312 and can engage the grow tube 300 adjacent to the openings 312 (e.g., similar to the manner in which the second tabs 116 engage the grow tube 100 adjacent to the openings 122, as shown in FIGS. 7-8).

In the illustrated embodiment, the openings 312 of the grow tube 300 comprise a circular shape. However, in other embodiments, the openings 312 can comprise various other shapes such as ovular, rectangular, etc.

In the illustrated embodiment, the locking tabs 314 of the grow tube 300 comprise a clamshell shape. However, in other embodiments, the locking tabs 314 can comprise various other shapes such as arrow shaped or other shapes comprising one or more locking surfaces.

In some embodiments, the grow tube 300 can comprise an adjustment mechanism comprising a plurality of openings 312 and/or a plurality of locking tabs 314 (e.g., similar to the adjustment mechanism 142 of the grow tube 100 shown in FIG. 13). Additionally or alternatively, in some embodiments, the grow tube 300 can comprise one or more vents (e.g., similar to the vent 136 of the grow tube 100) and/or one or more anchor-receiving openings (e.g., similar to the anchor-receiving openings 134 of the grow tube 100).

FIG. 19 shows a grow tube 400, according to yet another embodiment. The grow tube 400 can comprise a first side 402, a second side (not shown), a first end portion 404, a second end portion 406, a first edge portion 408, and a second edge portion 410. Although not shown, the grow tube 400 can be folded into the tubular configuration by radially overlapping the first and second edge portions 408, 410 (e.g., similar to the manner shown in FIGS. 7-8 with the grow tube 100).

The grow tube 400 can further comprise integrally formed locking features to retain the grow tube in the tubular configuration. For example, the locking features of the grow tube 400 comprise receiving elements (e.g., slits 412) and locking elements (e.g., locking tabs 414). The locking tabs 414 can be inserted through the slits 412 and engage the grow tube 400 adjacent to the slits 412 (e.g., similar to the manner in which the second tabs 116 engage the grow tube 100 adjacent to the openings 122, as shown in FIGS. 7-8).

In the illustrated embodiment, the locking tabs 414 of the grow tube 400 comprise a clamshell shape. However, in other embodiments, the locking tabs 414 can comprise various other shapes such as arrow shaped or other shapes comprising one or more locking surfaces.

In some embodiments, the grow tube 400 can comprise an adjustment mechanism comprising a plurality of slits 412 and/or a plurality of locking tabs 414 (e.g., similar to the adjustment mechanism 142 of the grow tube 100 shown in FIG. 13). Additionally or alternatively, in some embodiments, the grow tube 400 can comprise one or more vents (e.g., similar to the vent 136 of the grow tube 100) and/or one or more anchor-receiving openings (e.g., similar to the anchor-receiving openings 134 of the grow tube 100).

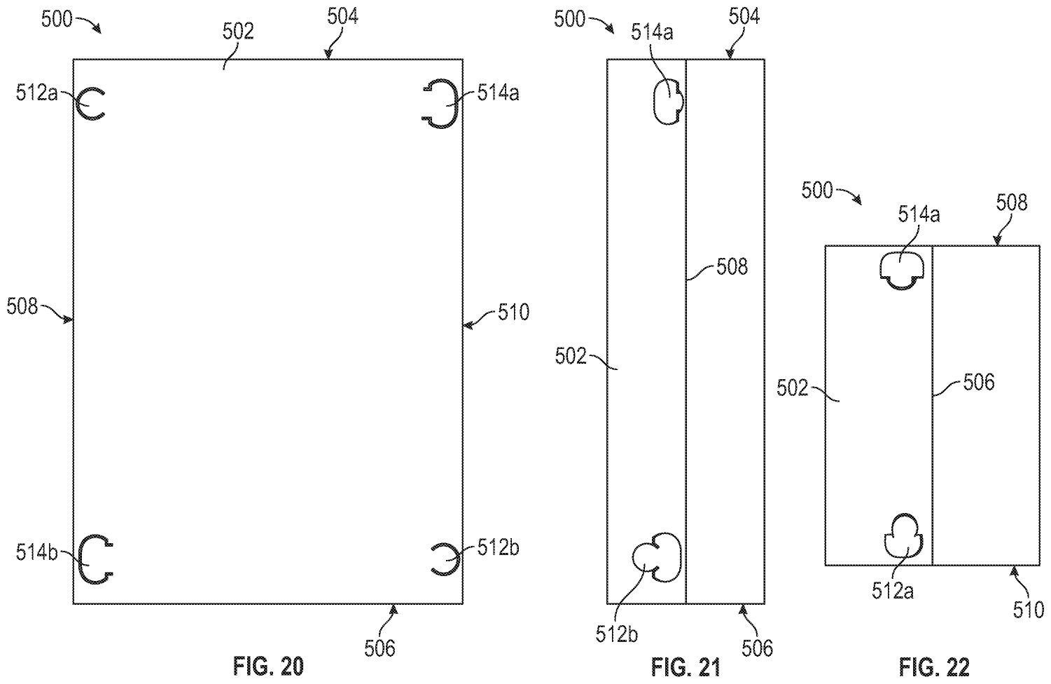

FIGS. 20-22 shows a grow tube 500, according to yet another embodiment. Referring to FIG. 20, the grow tube 500 can comprise a first side 502, a second side (not shown), a first end portion 504, a second end portion 506, a first edge portion 508, and a second edge portion 510.

The grow tube 500 can further comprise integrally formed locking features to retain the grow tube in the tubular configuration. For example, the locking features of the grow tube 300 comprise receiving elements (e.g., receiving tabs 512a, 512b, collectively referred to as “the receiving tabs 512”) and locking elements (e.g., locking tabs 514a, 514b, collectively referred to as “the locking tabs 514”). As shown in FIG. 20, the receiving tabs 512 are located diagonally relative to each other (e.g., a first receiving tab 512a is disposed at the corner formed by the first end portion 504 and the first edge portion 508 and a second receiving tab 512b is disposed at the corner formed by the second end portion 506 and the second edge portion 510). The locking tabs 514 are also located diagonally relative to each other (e.g., a first locking tab 514a is disposed at the corner formed by the first end portion 504 and the second edge portion 510 and a second locking tab 514b is disposed at the corner formed by the second end portion 506 and the first edge portion 508). The locking tabs 314 can be inserted through the openings 312. The locking tabs 314 can engage the grow tube 300 adjacent to the openings 312 (e.g., similar to the manner in which the second tabs 116 engage the grow tube 100 as shown in FIGS. 7-8).

Configuring the grow tube 500 with the receiving tabs 512 located diagonally from each other with the locking tabs 514 located diagonally relative to each other allows the grow tube to be folded into a plurality of tubular configurations, as shown in FIGS. 21-22.

For example, as shown in FIG. 21, the grow tube 500 can be folded into a first tubular configuration by radially overlapping the first and second edge portions 508, 510, interlocking the first receiving tab 512a with the first locking tab 514a, and interlocking the second receiving tab 512b with the second locking tab 514b. Folding the grow tube 500 in this manner creates a relatively tall, narrow tubular configuration.

FIG. 22 shows the grow tube folded into a second tubular configuration by radially overlapping the first and second end portions 504, 516, interlocking the first receiving tab 512a with the second locking tab 514b, and interlocking the first locking tab 514a with the second receiving tab 512b. Folding the grow tube 500 in this manner creates a relatively wide, short tubular configuration.

In the illustrated embodiment, the receiving tabs 512 of the grow tube 500 comprise a semi-circular shape. However, in other embodiments, the receiving tabs 512 can comprise various other shapes such as ovular, rectangular, etc. In yet other embodiments, the grow tube 500 can comprise openings and/or slits in lieu of the tabs 512.

In the illustrated embodiment, the locking tabs 514 of the grow tube 500 comprise a clamshell shape. However, in other embodiments, the locking tabs 514 can comprise various other shapes such as arrow shaped or other shapes comprising a locking surface.

In some embodiments, the grow tube 500 can comprise an adjustment mechanism comprising a plurality of receiving tabs 512 and/or a plurality of locking tabs 514. In some embodiments, the grow tube 500 can have a plurality of tabs 512, 514 extending in a row along the end portions 504, 506 (i.e., horizontally in the orientation depicted in FIG. 20), which allows the diameter of the grow to be adjusted when the grow tube is in the first tubular configuration (e.g., FIG. 21). Additionally or alternatively, the grow tube 500 can have a plurality of tabs 512, 514 extending in a column along the edge portions 508, 510 (i.e., vertically in the orientation depicted in FIG. 20), which allows the diameter of the grow tube 500 to be adjusted when the grow tube is in the second tubular configuration.

In some embodiments, the grow tube 500 can comprise one or more vents (e.g., similar to the vent 136 of the grow tube 100) and/or one or more anchor-receiving openings (e.g., similar to the anchor-receiving openings 134 of the grow tube 100).

The grow tubes described herein can be formed of various materials. For example, the grow tubes can be formed of various polymeric materials such as polyethylene and/or polypropylene. It is also contemplated that the grow tubes can be formed of various other materials including metals (e.g., steel) or plant-based products (e.g., cardboard, fiberboard, bioplastic, etc.).

In some embodiments, the grow tube can be formed such that it is biased to the tubular configuration. This can be accomplished, for example, by cutting the grow tube from a roll of material (as opposed to a sheet of material). In this manner, the grow tube will tend to assume the tubular configuration. In such configurations, the grow tube can be retained in the flat configuration (e.g., for forming the openings, vents, etc. and/or for transporting or storing) by strapping, a box, and/or other holding mechanism. Accordingly, as used herein, the term “flat configuration” means that the edge portions of the grow tube are released from each other and the grow tube is capable of being flattened to a single layer (see, e.g., FIG. 1), not necessarily that the grow tube is flat without any external forces applied thereto. Thus, the tubular configuration can also be referred to as a “secured configuration,” and the flat configuration can also be referred to as an “unsecured configuration.”

In some embodiments, the grow tube can also be formed from a single-wall material (as opposed to multi-layer materials and/or corrugated materials). This allows the grow tube to be relatively inexpensive, easy to manufacture, and/or reduces raw material consumption. In other embodiments, the grow tube can be formed from multi-layer material and/or corrugated material.

Configuring the grow tube so that it can be moved between the flat and tubular configurations and/or from a single-wall material also provides advantages for transporting and storing the grow tubes. For example, the grow tubes can be transported and/or stored in the flat configuration. This allows more grow tubes to be transported and/or stored per unit volume than grow tubes that are always in a tubular configuration or that are formed of a multi-layer material.

The grow tubes disclosed herein can be configured to accommodate various types of plants. For example, in some embodiments, the grow tubes can be configured for use with hazelnut trees and/or grape vines.

The structural features described herein, with regard to any example, can be used separately and/or combined with other structural features described in any one or more of the other examples. For example, a grow tube can comprise the vent 136, but omit one or more other features such as the first and second tabs 114, 116 and/or the anchor-receiving openings 134 (or vice versa). As another example, the grow tube 300, 400, and/or 500 can comprise the vent 136 of the grow tube 100. In another example, the grow tube 100 can comprise the openings 312 of the grow tube 300 rather than the first tabs 114 (or vice versa). In yet another example, the grow tube 100 can comprise the slits 412 of the grow tube 400 rather than the first tabs 114 (vice versa).

In view of the many possible embodiments to which the principles of the disclosure may be applied, it should be recognized that the illustrated embodiments are only examples and should not be taken as limiting the scope of the claims. Rather, the scope of the claimed subject matter is defined by the following claims and their equivalents.

1. A grow tube comprising:
a first side;
a second side, wherein the second side is opposite the first side;
a first end portion;
a second end portion, wherein the second end portion is opposite the first end portion;
a first edge portion;
a second edge portion, wherein the second edge portion is opposite the first edge portion, and wherein the first and second edge portions and the first and second end portions define the first and second sides;
a first opening extending between the first side and the second side and disposed adjacent to the first edge portion; and
a locking tab disposed on the first and second sides, between the first and second edge portions, and adjacent to the second edge portion, wherein the locking tab includes one or more locking surfaces configured to engage the first side or the second side adjacent to the first opening and to retain the first and second edge portions together,
wherein the grow tube forms a tubular configuration when the first and second edge portions are releasably secured together by the locking tab.

2. The grow tube of claim 1, wherein the first opening is defined by a receiving tab.

3. The grow tube of claim 1, wherein the locking tab has a stem portion and a main body portion, and wherein the locking surfaces are disposed between the stem portion and the main body portion.

4. The grow tube of claim 1, wherein the locking tab has a clamshell shape.

5. The grow tube of claim 1, further comprising a second opening extending between the first side and the second side, wherein the second opening is defined by the locking tab and is configured for receiving a receiving tab that defines the first opening.

6. The grow tube of claim 1, wherein the first opening is one of a plurality of first openings, and the locking tab is one of a plurality of locking tabs, and wherein each of the locking tabs is configured to interlock with a respective first opening.

7. The grow tube of claim 1, wherein the grow tube is formed from a single-wall material.

8. The grow tube of claim 1, wherein the grow tube is movable between the tubular configuration and a flat configuration.

9. The grow tube of claim 1, further comprising an adjustment mechanism configured for adjusting a diameter of the grow tube in the tubular configuration.

10. The grow tube of claim 9, wherein the first opening is one of a plurality of first openings, and wherein the adjustment mechanism comprises the plurality of first openings and the locking tab.

11. The grow tube of claim 1, wherein the first and second sides comprise a vent configured to allow airflow through the grow tube.

12. The grow tube of claim 11, wherein the vent comprises a flap and an opening.

13. The grow tube of claim 11, wherein the vent comprises a V-shape.

14. A grow tube comprising:
a first side;
a second side, wherein the second side is opposite the first side;
a first end portion;
a second end portion, wherein the second end portion is opposite the first end portion;
a first edge portion;
a second edge portion, wherein the second edge portion is opposite the first edge portion, and wherein the first and second edge portions and the first and second end portions define the first and second sides; and
a vent extending between the first side and the second side, wherein the vent comprises a flap and an opening.

15. The grow tube of claim 14, wherein the flap of the vent is V-shaped.

16. The grow tube of claim 14, wherein the flap of the vent is configured to direct a fluid away from the opening of the vent when the fluid is disposed on the first side of the grow tube.

17. The grow tube of claim 14, wherein the flap of the vent is configured to prevent a fluid from contacting a plant disposed within the grow tube.

18. A grow tube comprising:
a first side;
a second side, wherein the second side is opposite the first side;
a first end portion;
a second end portion, wherein the second end portion is opposite the first end portion;
a first edge portion;
a second edge portion, wherein the second edge portion is opposite the first edge portion, and wherein the first and second edge portions and the first and second end portions define the first and second sides; and
an adjustment mechanism comprising a plurality of openings and one or more tabs, wherein the tabs are configured to selectively engage the grow tube adjacent to respective openings, thereby releasably securing the grow tube in a tubular configuration, wherein the adjustment mechanism allows the grow tube to be positioned in a plurality of diameters in the tubular configuration.

19. The grow tube of claim 18, wherein the openings are spaced apart from each other and aligned in a row extending between the first edge portion and the second edge portion.

20. The grow tube of claim 18, wherein the openings are spaced apart from each other and aligned in a column extending between the first end portion and the second end portion.
